(19) United States
(12) Patent Application Publication
(10) Pub. No.: US 2004/0224063 A1
(43) Pub. Date: Nov. 11, 2004

(54) Pet food treat and method of making same

(76) Inventors: Joseph P. Markham, Arvada, CO (US); Thomas Kieth Martin, Amarillo, TX (US)

Correspondence Address: SHERIDAN ROSS PC, 1560 BROADWAY, SUITE 1200, DENVER, CO, 80202

(21) Appl. No.: 10/431,490

(22) Filed: May 6, 2003

(51) Int. Cl. A23P 1/00

(52) U.S. Cl. 426/481; 426/516

(57) ABSTRACT

A food product and method of making the same are disclosed. The food product is preferably made of a processed Sorghum grain, and preferably from hybrids of Milo. The grain is subjected to decortication and extrusion. Additives may be provided to flavor or otherwise nutritionally enhance the processed Milo. The additives are added prior to extrusion. In another embodiment, the food product may be made from other grains or tubers by removing the starch and then using the starch to extrude the food product.

### FIELD OF THE INVENTION

The present invention relates to the production of food products, and more particularly to pet food teats, and methods of making the food products by extrusion of suitable grain.

### BACKGROUND OF THE INVENTION

Pet foods for dogs and cats are typically prepared as either canned or dry meal type rations. These rations are commonly formulated from a combination of proteinaceous and farinaceous materials. Farinaceous materials are derived from various cereal grains, and proteinaceous materials are derived from either vegetable protein sources or from meat and/or meat by-products. It is also well known to add various nutritional supplements to both meal and canned rations such as vitamins, minerals, etc.

Dry meal type rations typically have a cereal-like texture and a low moisture content around 10%. Dry rations can be produced to provide a completely balanced diet for an animal. Dry rations also have excellent storage characteristics, thus permitting use of relatively inexpensive packaging techniques.

Canned rations have a meat-like texture and a high moisture content. The elevated moisture content of such canned foods requires thermal processing in sealed containers to obtain a commercially sterile product, thereby adding considerably to product costs. Once a can is opened, it must be quickly consumed since the high moisture content is conducive to supporting microbial growth, and hence the product will deteriorate rapidly unless stored in refrigerated conditions.

A third type of animal food has become popular more recently which can be characterized as intermediate moisture products, typically having a moisture content in the range of about 15 to 30%. For these intermediate products, in order to prevent microbial decomposition, such products must be specially processed through pasteurization, or must be chemically treated with various preservatives, and/or must be packaged in sealed containers which are commercially sterilized. Another approach to preserving these intermediate moisture products is to disperse an aqueous phase of water-soluble solids throughout the product, the soluble solids being principally sugar at a level high enough to exert a bacteriostatic effect sufficient to stabilizing animal food. Like canned rations, these intermediate products are more expensive to produce because of the need to specially package or preserve the products.

Conventional methods for producing dry rations involve either extrusion or pelletizing techniques wherein the dry rations are formed in a desired size and shape for a particular animal. The mixed farinaceous and/or proteinaceous sources of dry rations in extrusion are subjected to the action of the extruding machine which mixes the materials, and exposes them to heat and elevated pressures thereby converting the materials to a flowable semi-liquid substance. The temperature of the mixed materials passing through the extruder is typically above 212° F. The heated materials are expelled through die in the extruder device to atmospheric pressure, so that the heated moisture within the mixture flashes to steam causing the material to expand into a cellular mass. The cellular mass is then cut into pieces of a desired length, dried to a stable moisture content, and then treated with a flavored coating or with a chemical coating to preserve the product. The materials used to make most dry rations are also mixed prior to extrusion with various chemical preservatives to enhance the stability of the ration, and/or to assist in extrusion of the material. Although dry rations have a relatively long shelf life, depending upon the particular type of cereal grain or protein source used in the extrusion, there is still a need to preserve the ration with some type of chemical preservative.

It is well known to use various types of cereal grains in an extrusion process to produce feed having characteristics reflective of the particular type of cereal grain which is used. One reference which discloses a method of making a pet snack food, to include disclosure of various of types of cereal grains which may be used to make pet food an extrusion process is the U.S. Pat. No. 5,894,029.

Another reference disclosing animal feed which is produced through an extrusion process, and composed of proteinaceous and/or farinaceous material, is the U.S. Pat. No. 4,143,169.

Among the cereal grains used for making pet food or pet treats, corn and wheat are perhaps the most well known. Other types of grains may be added in smaller portions to the larger portions of wheat or corn in those dry food rations which are made by extrusion.

As pet food and pet food treats continue to develop in sophistication based upon a market which is increasingly conducive to sale of diversified pet products, new techniques for producing the pet foods also continue to develop. Despite pet food product diversification, basic food production still includes the need to provide healthy, inexpensive, and easily packaged food products.

Sorghum Vulgare is perhaps the oldest domesticated plant known to man. It is has been hybridized since early Egyptian years and is very diversified in its hybrid state. Varieties commonly referred to as Milo have few if any uses other than for animal feed. Sorghum Vulgare is widely used in the United States as a less expensive feed grain in comparison to corn or wheat. Other parts of the world, particularly Africa and Asia, use Sorghum for flour and human food. In the United States, Milo as a particular group of hybrids, is a very different type of cereal grain as compared to Sorghum which is grown in other parts of the world. In the United States, a need was established early on for developing a feed grain that was resistant to various growing problems. These problems included drought, insect infestations, migrating birds, and high winds. As a result of these factors, Milo has evolved into special hybrids which are able to withstand the various growth problems. Accordingly, the type of Sorghum available particularly in the United States is a very successful grain, but is not well suited for any use other than standard feed grain.

### SUMMARY OF THE INVENTION

One object of the present invention is to provide an animal food product which utilizes a grain which is inexpensive, easily extrudable, and has high nutrition value.

Another object of the present invention to provide an animal food product which may readily accept a flavoring or additive prior to the extrusion process thereby eliminating the need for a separate processing step in incorporating the additive.

It is yet another object of the present invention to provide an animal food product which may be varied in its texture, weight, size and density based upon the moisture content of the materials which are extruded to make the food product.

It is yet another object of the present invention to provide an animal food product which has an extended shelf life, and does not require chemical preservatives in order to maintain the extended shelf life.

It is yet another object of the present invention to provide a process for making an animal food product wherein the process may be easily adapted to produce animal food products of a desired size, density, weight, nutritional value and flavorings.

The products of the present invention comprise a matrix preferably manufactured from Milo seeds which at least have been decorticated resulting in berry and berry particulates which may then be exposed directly to extrusion. Additives may be added to the processed Milo prior to extrusion. The additives may be nutritional supplements and/or specific flavorings which enhance the nutritional value and palatability of the product.

In accordance with a first embodiment of the method of the present invention, a desired stock of Milo grain is chosen, and the selected grain is cleaned and sized. In the cleaning operation, a destoning operation may be incorporated to remove any hard material of like size and shape, such as small stones or pebbles. The Milo grain is then decorticated in one of several known methods of grain decorticating. The decortication removes the husks or hulls of the Milo seeds. Optionally, the remaining berry and berry particulates are then passed through a scourer to remove the fatty endogerm portion of the berries. De-fatting of the berries can enhance the ability of the Milo grain to be extruded because fat can act as a lubricant in extrusion thereby degrading the ability of an extruder to produce a consistent food product.

The next step in production of the food is an extrusion wherein a baked-type extruder is used under preferred heat and pressure ranges. The product produced in the extrusion process can be defined as a matrix of Milo which may carry an additive such as flavorants. One advantage of extrusion is that it also serves to kill bacteria and other microbes thereby helping to provide a product of increased shelf life. One final step which may be required in the process is to cure the product, preferably at a room temperature with a minimum of 60% air moisture content, until the product is stable. This last curing step is affected by the type of additives which may be added to the matrix.

In accordance with a second embodiment of the present invention, other types of grains or even tubers may be used to produce a desired food product wherein the method of production requires an additional step of removing the starch from the grain/tuber. Other grains which may be selected include corn, wheat, rice, and others. The extracted starch is the portion of the grain/tuber which is used, and the remaining portions are discarded. Typically, for starch based products which are extruded, flavorings are not added until after the extrusion process thereby increasing the complexity and overall cost of producing the food product. With the second embodiment of the present invention, this later flavor adding step can be eliminated by directly adding the flavorings prior to extrusion. In this second embodiment, an additional step is required which is to remove the starch from the rest of the grain or tuber, the removed starch typically being in a powdered form. The starch may be removed in any well-known starch removal process to produce a basic starch powder.

Other features and advantages of the present invention will become apparent from a review of the following detailed description, taken in conjunction with the drawing, which illustrates the preferred embodiments of the method of the present invention.

### BRIEF DESCRIPTION OF THE DRAWING

FIG. 1 is a flowchart showing the basic steps used in processing Milo grain to produce a food product according to the present invention.

### DETAILED DESCRIPTION

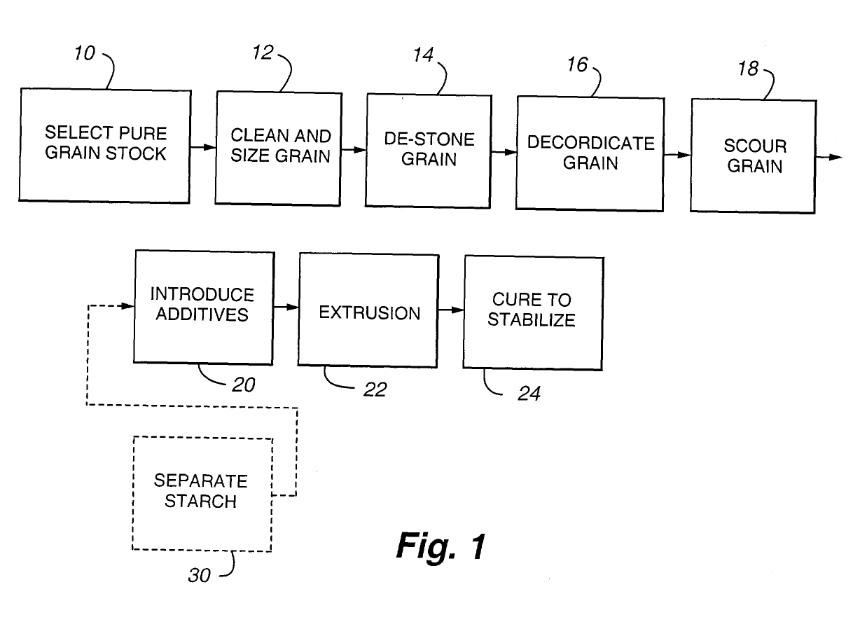

Referring to FIG. 1, the basic steps in the methods of making the food product of the present invention is illustrated. In a first step at block 10, a pure stock of grain Milo is selected. Although there is no specific hybrid of Milo which is required for the product and method of the present invention, it is desirable to choose a single pure stock grain because this pure stock grain is advantageous in creating repeatability of the extrusion process. Each hybrid of Milo may contain its own unique protein sequence. Even small differences in protein sequence may alter a particular extrusion. Therefore, by deliberately selecting grains with the same desired protein sequence, extrusion can be more reliably repeated.

The next step in the process shown at block 12 is to clean and size the Milo grain. Standard cleaning and sizing equipment may be used to process the grain at this step wherein air/water streams may be used to clean the grain, and the grain may be passed through various sieves to obtain the desired grain size. There is no required grain size for the present invention, and it has been found in testing that many different grain sizes can be used with good extrusion results.

Shown at block 14 is a next step in the process which is an optional destoning operation to remove stones or other similar sized objects which may still remain in the grain after cleaning and sizing. Although a destoning operation is shown as a separate optional step, destoning can be incorporated within a cleaning and sizing operation at step 12. Therefore, it shall be understood that although destoning is shown separately in the flowchart, is not necessarily required to be a separate step in the method. Any well known destoning operation can be used.

The next step in the process is shown at block 16 which is the decortication of the Milo grain. Any one of several methods of usual grain decortication may be used to decorticate the Milo. For example, two references which disclose methods for decorticating Milo and which have been found to be particularly effective are the methods described in the U.S. Pat. Nos. 5,713,526 and 5,820,039. These two references are incorporated herein by reference for purposes of disclosing basic methods by which Milo grain may be decorticated. Another common method of decortication involves swirling the grain in a cyclone at a high rate of speed against a rasping surface. The grain contacts the rasping surface and breaks into pieces wherein the lighter, less dense hull is separated from the berry. Yet another common method is to expose the Milo grain to a stream of high-pressure water which separates the berry from the hull of the grain.

The next step in the method is shown at block 18 which is an optional step of scouring the grain to remove fatty oils or lipids. There are two distinct advantages for de-fatting the Milo grain at this stage. The first is enhancing the consistency and repeatability of the extrusion process because fats in the grain tend to act as a lubricant through the extrusion die, thereby degrading extruder operation. The second advantage is the production of a more nutritional pet food which has less fat content. Well-known grain scouring processes may be used to remove the fatty endogerm from the Milo grain. Although scouring is discussed as a step in the basic method, it shall be understood that scouring is not necessarily required as it may be desirable in some circumstances to have certain levels of fat within the food product. Additionally, scouring may be eliminated to simplify the overall food production process.

The next step in the method is shown at block 20 which involves introduction of a desired additive(s) to the processed Milo. The Milo and additive(s) may be referred to as a grain mix. For pet food, there are a number of additives which are contemplated within the present invention which may be advantageous for pet food or pet treats. Examples of these additives include additives in the form of food meals which may be derived from vegetable or animal protein sources. More specifically, one particular type of meal may include a liver meal which is known to be preferred by almost all dogs. To create a pet treat incorporating this liver meal having a light and puffy texture, the mixture ratio of the Milo to the liver meal would be from about 7:1 to about 12:1 by weight. Preferably, the ratio of the Milo to the liver meal is about 9:1 by weight. In order to provide an extrudable mixture, it is preferable to maintain the Milo at or around 16% moisture, and the liver meal at or around 20% moisture. Alternatively, to produce a pet treat which is not as puffy but rather is denser, smaller, and has more of a crunchy, nugget consistency, the ratio of Milo to liver meal would be from about 1:2 to about 5:2 by weight. Preferably, the the ratio of Milo to liver meal would be about 3:2 by weight. For this denser product, the moisture content prior to extrusion is preferably about 18-22%. Other additives which may be used include vitamins, minerals or other nutritional supplements. These additives can be added at this step in prescribed amounts which do not pose a health risk to the animals even in the event that a particular animal would consume a large number of the treats at a single time. Other types of additives which are also contemplated include medications, peanuts, fish meal, poultry meal, dried fruits or vegetables, flavored oils or other concentrated liquid flavorants. Milo is a grain which readily accepts a variety of additives, and there is little if any segregation or separation between the Milo grain and the additives in the extruded food product.

It may be desirable to mechanically mix the grain mix in a bin which will then meter the grain mix into the extrusion machine. Mechanical mixing helps to ensure uniform dispersion of the additive. It is also necessary to add water to the decorticated grain in order to create the grain mix with the necessary moisture content. It has been found in testing that Milo has approximately 10-12% moisture content prior to processing. In order to optimize extrusion, it has been found through testing that a moisture content of about 16% is preferable.

The next step in the method is illustrated at block 22 which involves extrusion of the Milo grain mix. Through testing, it has been found that extrusion can be achieved utilizing a bake-type extruder which exposes the grain mix to heat in the range of about 325° F. to about 400° F., and pressure in the range of about 1500 psi to about 2,000 psi. The particular shape of the die used in the extruding machine may be adapted to produce a food product of a desired shape. One example of a die could include the use of a die having a round shaped hole with a diameter of approximately 0.120 inch. The cutting mechanism used in the extruding machine can be adapted for cutting the extrudate to a length of about three-quarters inch. For a grain mix which is extruded having an overall moisture content of approximately 16%, the resulting extruded product has a light, puffy and cellular consistency at moisture contents above about 18%. As moisture content is increased in the grain mix, the resulting food product is smaller and denser as the product will experience less expansion during extrusion. For example, a food product having a more nugget-like consistency can be produced which is still crunchy, but does not have the puffy, cellular consistency. Temperature and pressure can also be adjusted within the extrusion process to produce a food product which is of a desired size, shape and density. Generally, increasing temperature and pressure will increase the expansion of the grain mix during extrusion.

The last step of the method is shown at block 24 which contemplates curing the food product to thereby stabilize the product prior to shipping. Depending upon the texture and consistency of the food product produced, i.e., one that is either puffed or more dense, a certain amount of curing may be required to allow the food product to reach equilibrium in terms of moisture content.

There are a number of advantages of utilizing a Milo matrix as a food product. First, there is the relatively low cost of producing such a food product as the processing steps for creating the Milo matrix can be achieved within a relatively simple grain processing method. Milo grain is a relatively high protein, low fat grain which is both palatable and easily digestible by both humans and animals. Processed Milo is generally hydrophobic, therefore very stable in all climates and storing conditions. Accordingly, the food product produced may be packaged and sold within packaging which does not have to be sealed or otherwise specially treated. For example, large bins of the Milo food product can be directly incorporated within retail locations where a consumer measures a desired amount of the food product to be purchased and then places the product into a plastic or paper bag. A Milo food product made by the above-described method requires no chemical additives to preserve the product for extended shelf life. Another advantage as mentioned above is the ability to produce food products which have a variety of densities. Lighter, puffier products as well as denser, crunchier products may be easily produced. By varying the temperature and pressure of the extrusion, or adjusting the moisture content, the particular size and density of the product can be chosen. For example, extruding the Milo grain mix through a die having a round opening of about 0.120 of an inch in diameter and at about 16% moisture content, can produce a product having a width/diameter of approximately three-quarters inch, which then can also be cut to a desired length. Increasing the moisture to about 18% has been shown to produce a product having a width/diameter of approximately one-half inch. During the extrusion process, the heat and pressure advantageously kill bacteria and other undesirable microorganisms thereby increasing the shelf life of the product. Also during extrusion, the additives become evenly mixed within the decorticated grain thereby producing a homogeneous mixture. Accordingly, the additive is evenly distributed throughout each batch of the extruded pet food product in contrast to many other types of pet treats, into which flavorings or additives are incorporated by an electrostatic process which simply coats the exterior surface of the product. These methods of incorporating a flavoring/additive are less desirable because the flavoring/additive is more easily separated from the product. By creating a homogeneous mixture through the extrusion process of the present invention, the desired additive is better delivered to the consuming animal.

In accordance with another preferred embodiment of the present invention, other types of grains may be used to produce the food product. For example, corn, wheat and rice can also be used as the basic grains which are processed in the present invention. With these grains; however, an additional processing step is required to remove the starch from the remaining part of the grain. The removed starch is typically in powder form. In their natural state, these other grains are very difficult to extrude successfully, and therefore, the part of the grain to be extruded, the amylose starch, is separated from the whole grain prior to extrusion. Milo also contains starch, best characterized as an amylose -pectin starch. However, after decortication, Milo is readily extrudable without also having to first isolate the starch component of the grain.

In addition to grains in which starch has been removed for use in extrusion, it is also contemplated within the present invention to use the starch extracted from tubers, such as potatoes. As with the Milo grain, these extracted starches must also receive the required amount of water to raise the moisture content to a desired level corresponding to the texture and density of the final product.

Referring again to FIG. 1, the additional step of separating the starch is shown at block 30 in dotted lines. Additives are added to the starch in step 20, and then the mixture is extruded at step 22. The final step again would be curing, as required, at step 24. In accordance with another aspect of the invention, the grain mix can also be mixed with a gelatin prior to extrusion thereby increasing the hardness of the resulting extruded food product.

The above invention has been described with respect to preferred embodiments; however, other changes and modifications may be made within the spirit and scope of the invention.

What is claimed is:

1. A food product comprising:
a decorticated Milo grain seed mixed with an additive, and then extruded to produce an extruded food product having a substantially homogeneous mixture of Milo seeds and the additive.

2. A food product, as claimed in claim 1 wherein:
said additive is selected from the group consisting of medications, vitamins, minerals, liver meal, peanuts, fish meal, poultry meal, dried fruit, dried vegetables, flavored oils, and concentrated liquid flavorants.

3. A method of producing a food product comprising the steps of:
cleaning a desired hybrid of Milo grain;
decorticating the grain;
introducing an additive creating a grain mix; and,
extruding the grain mix to create an extrudate food product.

4. A method, as claimed in claim 3, wherein:
moisture content of the grain mix prior to extrusion is about 16%.

5. A method, as claimed in claim 3, wherein:
said at least one additive is selected from the group consisting of medications, vitamins, minerals, liver meal, peanuts, fish meal, poultry meal, dried fruit, dried vegetables, flavored oils, concentrated liquid flavorants, and combinations thereof.

6. A method, as claimed in claim 3, further comprising the step of:
scouring the grain prior to extrusion to remove fatty endogerm of the grain.

7. A method, as claimed in claim 3, further comprising the step of:
destoning the grain prior to the step of decorticating the grain.

8. A method, as claimed in claim 3, further comprising the step of:
altering the moisture content of the grain mix to thereby vary the density of the extrudate.

9. A method, as claimed in claim 3, further comprising the step of:
curing the extrudate food product.

10. A method, as claimed in claim 3, wherein:
increasing the moisture content of the grain mix prior to extrusion produces a smaller, denser extrudate, and lessening the moisture content of the grain mix produces a larger, less dense extrudate.

11. A method, as claimed in claim 3, wherein:
moisture content prior to extrusion is in the range of about 16% to about 22%.

12. A method of producing a food product comprising the steps of:
selecting a desired grain;
cleaning the grain;
decorticating the grain;
removing the starch from the grain;
combining the removed starch with an additive creating a starch mix;
extruding the starch mix to produce an extrudate; and
curing the extrudate.

13. A method as claimed in claim 12, wherein:
said additive is selected from the group consisting of medications, vitamins, minerals, liver meal, peanuts, fish meal, poultry meal, dried fruit, dried vegetables, flavored oils, and concentrated liquid flavorants.

14. A method of producing a food product comprising: extruding a decorticated Milo grain.

15. A method of producing an extruded food product comprising extruding a cleaned and decorticated Milo grain having an additive selected from the group consisting of medications, vitamins, minerals, liver meal, peanuts, fish meal, poultry meal, dried fruit, dried vegetables, flavored oils, concentrated liquid flavorants, and combinations thereof
